(19) United States
(12) Patent Application Publication
(10) Pub. No.: US 2015/0351410 A1
(43) Pub. Date: Dec. 10, 2015

(54) EGG BAKING DEVICES

(71) Applicants: Stephen Paul Galbincea, Shaker Heights, OH (US); Joseph K. Juster, Shaker Heights, OH (US); Christopher M. Nook, Russell, OH (US)

(72) Inventors: Stephen Paul Galbincea, Shaker Heights, OH (US); Joseph K. Juster, Shaker Heights, OH (US); Christopher M. Nook, Russell, OH (US)

(21) Appl. No.: 14/729,867

(22) Filed: Jun. 3, 2015

Related U.S. Application Data
(60) Provisional application No. 62/007,617, filed on Jun. 4, 2014.

(51) Int. Cl. A21B 5/00; A21B 3/13

(52) U.S. Cl. CPC A21B 5/00; A21B 3/135

(57) ABSTRACT

An egg baking device is provided. The egg baking device includes a body or tray having one or more cavities for receiving eggs to be baked. In various embodiments, the body or tray is ventilated to allow air to flow around the eggs during baking to ensure that each egg is evenly cooked to the desired condition.

### CLAIM OF PRIORITY

This application claims the benefit of priority of Galbincea et at, U.S. Provisional Application Ser. No. 62/007,617 filed Jun. 4, 2014, titled “EGG BAKING DEVICES” (Attorney Docket No. 35983/04000) which is hereby incorporated by reference herein in its entirety.

### FIELD OF THE INVENTION

The general inventive concepts of the present application relate generally to cookware, and more specifically, to egg baking devices.

### BACKGROUND

Eggs are cooked using a variety of known methods. One conventional method for cooking eggs within their shell includes boiling one or more raw eggs in water. Often the boiled eggs are then immediately transferred into either cold water or an ice bath to cool the eggs. However, this method requires ongoing supervision of the boiling water by the cook, and often results in raw eggs either cracking or breaking during the cooking process as well as having other drawbacks. Thus, there exists a need for an egg cooking device that eliminates the need for boiling water, yet still produces an egg that is uniformly cooked to a desired consistency inside its shell.

### SUMMARY

In one exemplary embodiment, the egg baking device includes a cup-shaped main body that defines a cavity for at least partially receiving one egg and a plurality of legs for supporting the main body. In some embodiments, the egg baking device is constructed from heat-resistant materials designed to withstand baking at high temperatures. The use of such heat-resistant materials in such embodiments may also serve to prevent or reduce burning or overcooking of the egg and/or browning or discoloring the egg or its shell during cooking.

In exemplary embodiments, the legs are configured to span at least two rails of a conventional oven rack so that the egg baking device can stably rest upon a conventional oven rack without being prone to tip over. Optionally, each leg may include a foot to aid in the proper positioning of the egg baking device across the rails of the oven rack. The risk of egg breakage during cooking is substantially reduced by the use of this device. In various embodiments, the egg baking devices may be constructed from non-slip materials, such as silicone rubber, to prevent the egg baking device from slipping relative to the surface supporting the egg baking device, whether before, after or during the baking process. For example, an exemplary egg baking device constructed, in whole or in part, from such non-slip material may be rested upon a baking sheet and resist sliding relative to the baking sheet during the inserting of the baking sheet (with the egg baking device placed thereon) into an oven.

In exemplary embodiments, the egg baking devices are configured to be stackable upon each other. The stackable egg baking devices of such embodiments help to conserve space in the storage of more than one such egg baking device. Furthermore the stackable egg baking devices of such embodiments may be configured to be stacked in a vertical stack or in an interlocking manner to form a pyramid or other shape for the purposes of the display of the egg baking devices at the point of sale or by a user in storing/displaying the egg baking devices in between uses.

In exemplary embodiments, the egg baking device includes one or more ridges located within the cavity of the main body for supporting an egg received within the egg baking device. In some embodiments the ridges serve to create a distance of separation from the outer surface of the egg and the main body of the egg baking device to provide for improved airflow around the egg during baking, to ensure that the egg is cooked evenly. Furthermore, the ridges of such exemplary egg baking devices also help to ensure that eggs of various sizes can be accommodated and placed within the egg baking device.

In exemplary embodiments, the egg baking device further includes one or more protrusion extending upwardly from the floor of the cavity of the main body to support an egg received within the egg baking device. In some embodiments the protrusion serve to create a distance of separation from the outer surface of the egg and the main body of the egg baking device to provide for improved airflow around the egg during baking, to ensure that the egg is cooked evenly, thus producing a fully cooked egg (i.e., suitable and safe for eating) that is uniformly cooked throughout.

In exemplary embodiments, the egg baking device further includes one or more vents defined through the main body to provide for improved airflow around and through the egg baking device and egg during baking. Such optional vents help to ensure that the egg cooks evenly, thus producing a fully cooked egg (i.e., suitable and safe for eating) that is uniformly cooked throughout.

In exemplary embodiments, the egg baking device includes a tray designed to conform to a conventional carton of one-dozen eggs. In additional embodiments, the egg baking device includes a tray and a removable base. In yet additional embodiments, the egg baking device includes a tray, a removable base and a cover. In some embodiments, the tray, base, and/or cover are constructed from heat-resistant materials designed to withstand baking at high temperatures. In some embodiments, the tray, base, and/or cover are ventilated.

In exemplary embodiments, the egg baking device is a carton, similar to a conventional egg carton, that is constructed from a heat-resistant materials designed to withstand baking at high temperatures. By use of such an egg carton that is constructed from a heat-resistant material, eggs can be packaged, shipped, sold to end-consumers in the carton and also baked in the oven. A consumer could purchase eggs packaged in such a carton from the store, take the eggs home in the carton, and place all or some of the eggs in the same carton into an oven to bake the eggs within the carton.

The use of the various exemplary egg baking devices disclosed herein provide a variety of benefits over conventional egg boiling methods. For example, the exemplary egg baking devices do not involve the use of boiling water so there is no risk of scalding. Furthermore, since no open flame is used, risks of burning are also diminished. Baking eggs using the egg baking devices disclosed herein is an easier, less labor intensive method than boiling eggs. Furthermore, it is more consistent and repeatable method of cooking eggs than boiling, as the oven temperature and baking time can be accurately and consistently controlled to ensure a fully and consistently cooked egg each time. The oven temperature and/or baking time can be adjusted to control the finished condition or “doneness” of the baked egg. For example, baked eggs having a similar consistency as hard boiled eggs or soft boiled eggs can be achieved by adjusting the baking parameters. Also, the consistency with which the eggs can be baked helps to avoid the health risks/downsides or undesirable taste/texture/appearance associated with undercooked or overcooked eggs.

Less labor and cleanup is required (and, therefore, less soap and water for cleaning purposes as a result) to clean the egg baking devices than conventional pots and cookware used for boiling eggs and the coldwater bath used for cooling the boiled eggs. Use of the egg baking devices disclosed herein also decrease the risk of egg breakage, as eggs are often broken when they are dropped into a pot of water, when they collide with one another during the pot during boiling, or even as a result of extreme temperature changes resulting from the transfer of the eggs from boiling water to the cold water bath.

The egg baking process using the egg baking devices can be more easily scaled to accommodate relatively large batches of eggs than the boiling process. Only a limited number of eggs can be conveniently boiled at one time within a pot, but exemplary embodiments of the egg baking devices disclosed herein could be configured to hold a large number of eggs that could all be placed within an oven and baked at the same time, at the same temperature, to achieve the same consistent result. Even large flats of many eggs could be baked in this way using large egg baking trays and industrial sized ovens, for use in restaurant, military, institutional or school environments. The egg baking devices disclosed herein can also be used with existing bakeware, such as cooking trays, cooking sheets or pie pans or other bakeware items that many people typically already possess. For example, the egg baking devices disclosed herein may be placed on or within a piece of conventional bakeware in an oven during the baking process.

Various exemplary features and advantages of the general inventive concepts will be set forth in part in the description which follows, and in part will be obvious from the description, or may be readily learned by practice of the general inventive concepts. The accompanying drawings, which are incorporated in and constitute a part of the instant application, illustrate one or more embodiments exemplifying the general inventive concepts, and together with the description, serve to explain the principles of the general inventive concepts.

### BRIEF DESCRIPTION OF THE DRAWINGS

FIG. 1A is a perspective view of one exemplary, non-limiting embodiment of an egg baking device;

FIG. 1B is a top plan view of the egg baking device of FIG. 1A;

FIG. 1C is sectional view taken along the plane indicated by lines C-C in FIG. 1B.

FIG. 1D is a side elevation view of the egg baking device of FIG. 1A;

FIG. 1E is a bottom plan view of the egg baking device of FIG. 1A;

FIG. 2A is a perspective view of a second exemplary, non-limiting embodiment of an egg baking device;

FIG. 2B is a top perspective view of the egg baking device of FIG. 2A with the optional cover removed and a conventional one-dozen carton of eggs being transferred into the egg baking device;

FIG. 2C is a front elevation view of the egg baking device of FIG. 2A;

FIGS. 3 is a perspective view of a third exemplary, non-limiting embodiment of an egg baking device;

FIGS. 4A-4C are perspective views of a fourth exemplary, non-limiting embodiment of an egg baking device;

FIG. 5A is a perspective view of a fifth exemplary, non-limiting embodiment of an egg baking device;

FIG. 5B is a front elevation view of the egg baking device of FIG. 5A;

FIG. 6A is a perspective view of a sixth exemplary, non-limiting embodiment of an egg baking device;

FIG. 6B is a perspective view of the egg baking device of FIG. 6A being inserted into a conventional muffin tin.

### DETAILED DESCRIPTION

The general inventive concepts will now be described with reference to specific embodiments thereof. The general inventive concepts may, however, be embodied in different forms and should not be construed as limited to the embodiments set forth herein. Rather, these exemplary embodiments are provided to facilitate disclosure of the general inventive concepts to those skilled in the art and are not intended to limit the scope of the general inventive concepts in any way.

Except as otherwise specifically defined herein, all terms used herein have the same meaning as commonly understood by one of ordinary skill in the art to which this present application belongs. The terminology used in the description of the present application herein is for describing particular embodiments only, and is not intended to be limiting of the present application. As used in the description of the general inventive concepts, the singular forms “a,” “an,” and “the” are intended to include the plural forms as well, unless the context clearly indicates otherwise.

Unless otherwise indicated, all numbers expressing quantities, properties, and so forth as used in the specification are to be understood as being modified in all instances by the term “about.” Accordingly, unless otherwise indicated, the numerical properties set forth in the following specification are approximations that may vary depending on the desired properties sought to be obtained in embodiments of the present application. Notwithstanding that the numerical ranges and parameters setting forth the broad scope of the present application are approximations, the numerical values to the extent that such are set forth in the specific examples are reported as precisely as possible. Any numerical values, however, inherently contain certain errors necessarily resulting from error found in their respective measurements.

With particular reference to the drawings, exemplary embodiments of the egg baking device are described below. The drawings disclosed herein should not be construed as limiting, but are provided for purposes of illustration.

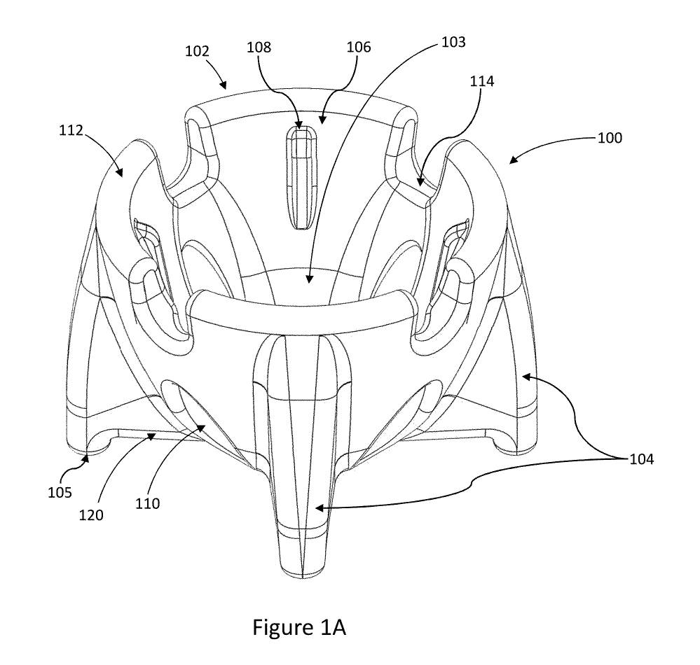

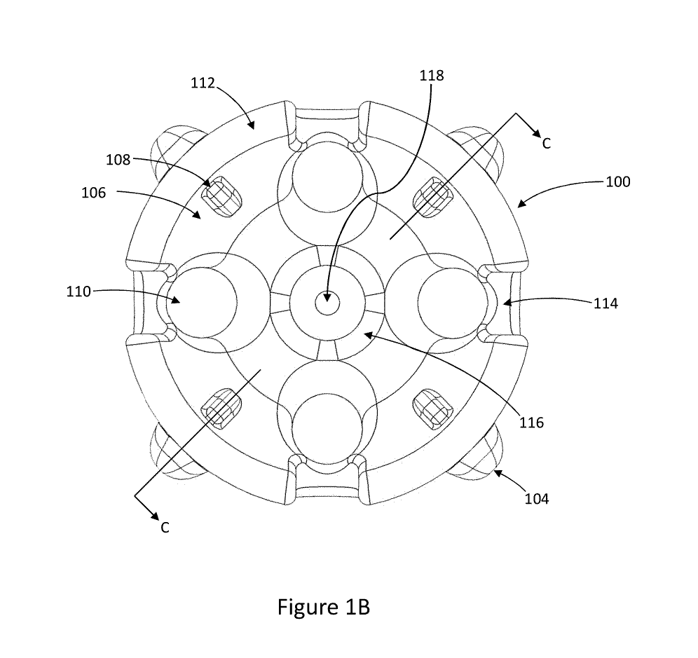

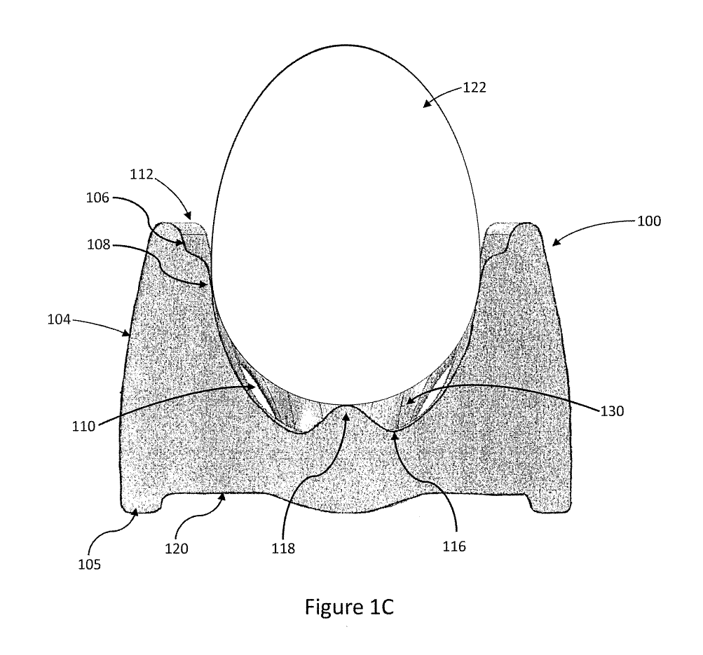

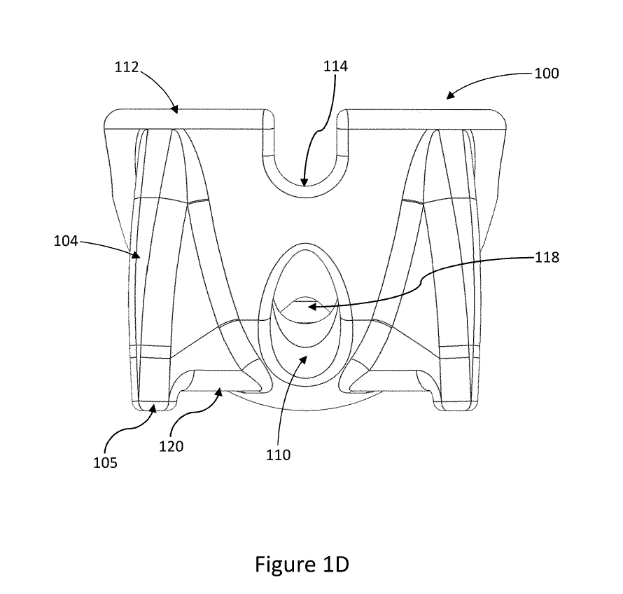

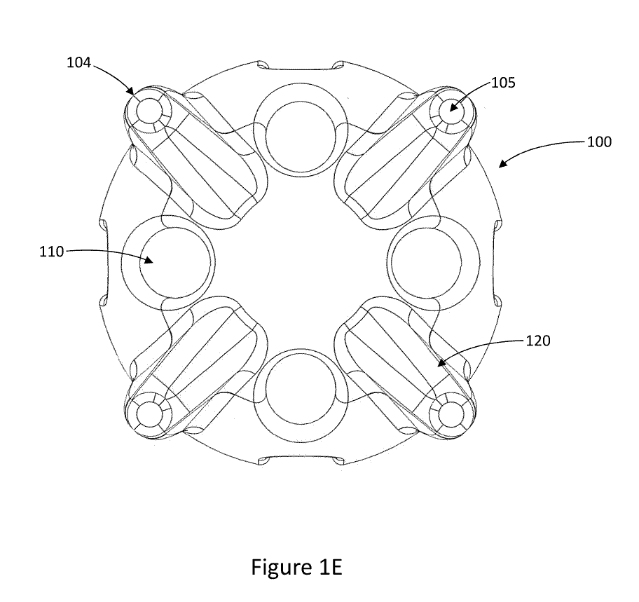

Referring now to FIGS. 1A-1E, an exemplary embodiment of an egg baking device 100 is shown. The main body 102 of the egg baking device 100 forms a cavity 103 for receiving an egg for baking. The inner surface 106 of the cavity 103 extends from a floor 116 to an upper rim 112 that encircles the cavity 103.

In the illustrated embodiment, a plurality of ridges 108 protrude from the inner surface 106 of the cavity 103, and a support 118 protrudes from the floor 116 of the cavity 103. The ridges 108 and support 118 keep the egg 122 centered in the cavity 103 and prevent the egg 122 from coming into contact with the inner surface 106 or floor 116 of the cavity 103, thus creating an air gap 130 between the egg 122 and the inner surface 106 and floor 116 of the cavity 103 of the egg baking device 100. The flow of hot air around the egg 122 being baked using the egg baking device 100 facilitates even cooking of the egg 122 to the consistency desired by the cook. Furthermore diminished contact of the egg with the surface of the egg baking device 100 helps to diminish the risk of “hot spots” forming on the eggs during baking and/or the egg or the egg shell from becoming burned, overcooked, or discolored. Providing for airflow around the egg during baking also helps to ensure that the egg cooks evenly, thus producing a fully cooked egg (i.e., suitable and safe for eating) that is uniformly cooked throughout to the condition desired by the cook.

The ridges 108 and/or support 118 may be configured such that an air gap 130 is maintained when eggs of various sizes are inserted into the egg baking device 100. As best illustrated in FIG. 1C, the ridges 108 of the illustrated embodiment have a generally sloped surface that slopes inwardly towards a central axis of the egg baking device 100. As a result of this sloped configuration, the ridges 108 are adapted to support eggs of various sizes (i.e., a larger egg will contact the ridges 108 at a higher point within the cavity 103 of the egg baking device, while a smaller egg will drop lower within the egg baking device and contact the ridges 108 at a lower point within the cavity 103).

It should be understood that both the ridges 108 and support 118 are optional and various additional embodiments of the egg baking device 100 may be provided without ridges and/or a support. For example, exemplary embodiments of the egg baking device 100 may include ridges 108 without including any support 108. Yet other exemplary embodiments may include support 118 and not include any ridges 108. It should also be understood that various numbers of ridges and supports may be provided in additional embodiments. For example, while the illustrated embodiment includes four ridges 108 and one support 118, additional embodiments of the egg baking device 100 may include different numbers or ridges 108 and supports 118. The size, dimension, and configuration of the ridge and/or support may vary in additional embodiments.

A plurality of vents 110 are defined in the inner surface 106 of the main body 102 to allow air to pass through the body 102 during baking. In the illustrated embodiment, the vents 110 are positioned between each leg 104 along the circumference of the inner surface 106 but may be located in various different locations in additional embodiments. The vents 110 may be any appropriate shape or size, and each vent 110 may be a single opening or may be comprised of many openings through the body 102 of the egg baking device 100. During baking, hot air flows from the exterior of the egg baking device 100, through the vents 110, and then through the air gap 130 created between the inner surface 106 and floor 116 of the cavity 103 and the egg 122. This flow of hot air around the egg 122 being baked using the egg baking device 100 facilitates even cooking of the egg 122 to the consistency desired by the cook.

A plurality of legs 104 are attached to the exterior of the body 102. The legs may be sized, dimensioned and configured differently in various embodiments. The illustrated embodiment is show with four legs, but additional embodiments of the egg baking device may include any number of legs. In the illustrated embodiment, each pair of adjacent legs 104 is dimensioned to span at least two rails of a conventional oven rack. The distance between each pair of adjacent legs of the illustrated exemplary embodiment is between approximately 1.5 to 2 inches. However, in various additional embodiments, the distance between the legs may differ. For example, in various embodiments, the distance between the legs of the egg device 100 may be between approximately 1 to 3 inches. In yet additional embodiments, the distance between the legs may be between ½ to 3.5 inches.

In various embodiments, all or a portion of the egg baking device 100 or all or a portion of one or more of the legs 104 may be constructed from a gripping, non-slip material, such as silicone rubber, to inhibit the egg baking device 104 from slipping or sliding relative to a surface supporting the egg baking device. For example, such an exemplary egg baking device 100 that is fully or partially formed from such a gripping, non-slip material may be rested upon a baking sheet and resist sliding relative to the baking sheet during the inserting of the baking sheet (with the egg baking device placed thereon) into an oven or other baking device.

In the illustrated embodiment, an optional foot 105 protrudes from the bottom of each leg 104 to help the cook optionally position the egg baking device 100 to span across the rails of a conventional oven rack. A support surface 120 spans the distance between each foot 105 and the body 102. The support surface of the illustrated embodiment is adapted to optionally rest upon one or more rails of an oven rack.

A plurality of notches 114 in the upper rim 112 of the cavity 103 are positioned and sized to facilitate stacking of multiple egg baking devices 100. Each notch 114 is wide enough to accept a leg 104 of an egg baking device 100. Thus, when multiple egg baking devices 100 are not in use they can be stacked on top of each other by inserting the legs 104 of one egg baking device 100 into the notches 114 in the upper rim 112 of another egg baking device 100. Due to the location and configuration of the notches 114 and the legs 104 of the egg baking devices, a stack of multiple egg baking devices 100 of the illustrated embodiment can be formed by rotating one egg baking device relative to an underlying egg baking device until the legs 104 of the upper egg baking device 100 align with and fit within the notches 114 of the underlying egg baking device. This action can then be repeated to allow for the staking of multiple egg baking devices upon one another. The stackable egg baking devices of such embodiments may be configured to be stacked in a vertical stack or in an interlocking manner to form a pyramid or a variety of other shape for the purposes of the display of the egg baking devices at the point of sale or by a user in storing/displaying the egg baking devices in between uses.

The egg baking device 100 may be formed of one or more of a variety of suitable materials. The material is generally selected to be a heat-resistant material designed to withstand baking at high temperatures. In additional embodiments, the material is also selected to remain cool to the touch even after being exposed to the raised temperatures of an oven for prolonged periods of time. For example, in some exemplary embodiments, the egg baking device 100 may be made from one or a combination of polymers, such as thermoplastic, thermoset or elastomeric materials. For example, in some exemplary embodiments, the egg baking device 100 may be made of silicone rubber or polyethylene-terephthalate (PET), or mixtures thereof which lessens the risk of “hot spots” forming on the eggs during baking and/or the egg or the egg shell from becoming burned, overcooked, or discolored. In some exemplary embodiments, the egg baking device 100 may be made from one or a combination of metals, such as steel or aluminum. In some exemplary embodiments, the egg baking device 100 may be formed from a non-metallic material. In various exemplary embodiments, the egg baking device 100 may be formed from a non-ceramic material. In yet additional embodiments, the egg baking device 100 may be made from a combination of polymeric materials and metals. For example, the egg baking device 100 may be made from aluminum or steel coated with silicone rubber. The egg baking device 100 may be manufactured by any suitable method, including any one of a variety of methods of making cookware that are well known in the art. For example, molding processes, such as injection molding, could be used with any of a variety of polymeric materials to make the egg baking device 100.

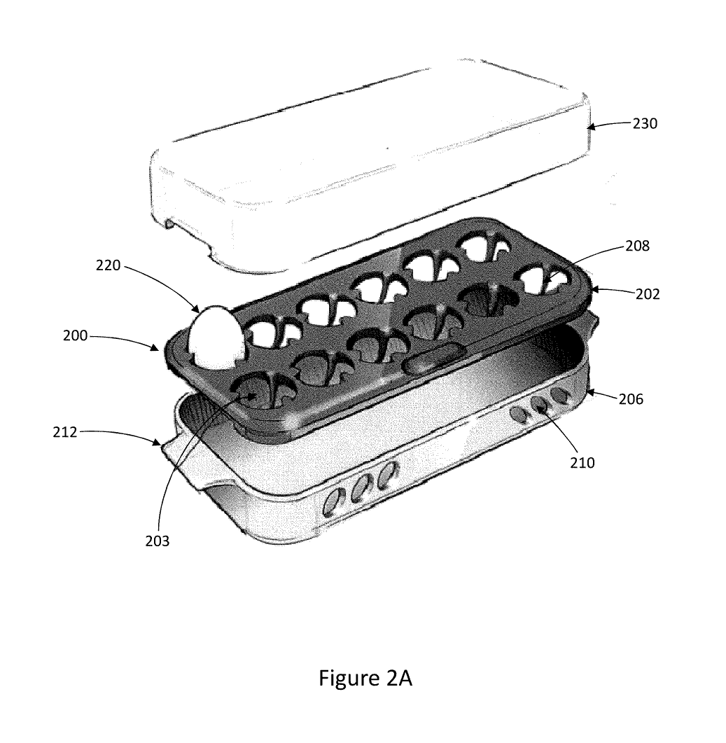

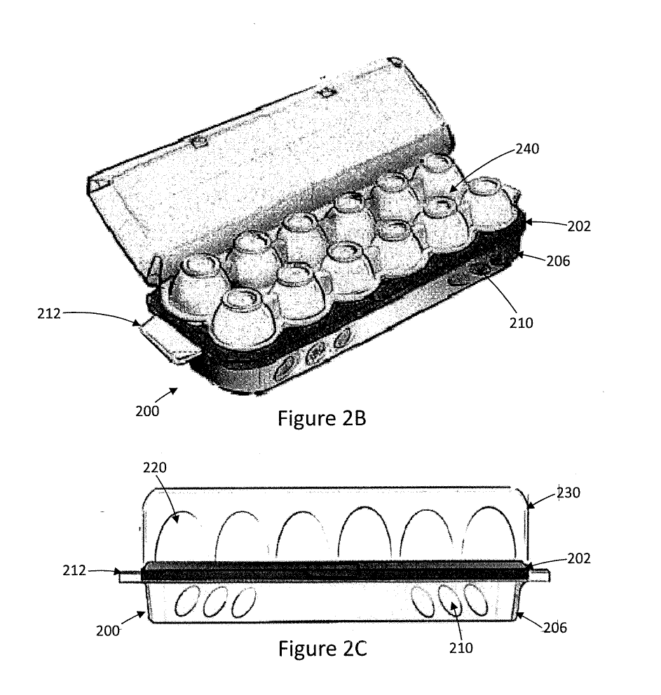

Referring now to FIGS. 2A-2C, a second exemplary embodiment of an egg baking device is shown. The egg baking device 200 includes a tray 202 having one or more cavities 203. Each cavity 203 is configured to house an egg 220 in an upright position. In certain embodiments, the tray 202 has one-dozen cavities 203 that are arranged to match the arrangement of eggs in a conventional carton 240 of one-dozen eggs.

Each cavity 203 in the tray 202 includes supports 208 that hold an egg 220 in an upright position. Other than the supports 208, each cavity 203 in the tray 202 is open, allowing hot air to flow around the egg 220 during baking, ensuring even cooking. The supports 208 are configured to accept eggs of a variety of sizes. The tray 202 may be made of any suitable heat resistant material. In certain embodiments, the tray 202 is made of silicone rubber.

The egg baking device 200 further includes a base 206 that supports the tray 202 during baking and storage, and can catch any debris if an egg 220 happens to break, though this possibility is made less likely by the use of the egg baking device 200. In some embodiments the base 206 and tray 202 may be a one piece, unitary construction. In particular embodiments where the base 206 is removable from the tray 202, the base 206 is configured such that the tray 202 sits on top of the base 206, or alternatively, is nested within the base 206. Vents 210 are included in the base 202 to allow hot air to flow through the base 202 and around the eggs 220 as they sit in their cavities 203 during baking. The vents 210 may take any suitable shape that allows air flow through the base 206 during baking, and in some embodiments are symmetrical ovals. The base 206 may optionally include one or more handles 212 to help the cook hold the egg baking device 200 when transferring it into and out of the oven or refrigerator. The base 206 may be made of any suitable heat resistant material. In some embodiments the base 206 is formed of metal, in others, the base 206 is formed of silicone rubber or other materials.

In certain embodiments the egg baking device 200 also includes a removable cover 230 that may sit on top of the tray 202, and in some embodiments resealably engages the tray 202. In certain other embodiments, the cover 230 sits on top of the base 206, and in other particular embodiments the cover 230 resealably engages the base 206.

Eggs 220 can be transferred from a traditional one-dozen egg carton 240 into the tray 202 by placing the tray 202 upside down over an open carton of eggs, holding the tray 202 and the carton 240 together, and then flipping the two over such that the eggs 220 are deposited into the cavities 203 of the tray as shown in FIG. 2B. The carton 240 can then be disposed of and the egg baking device 200 now full of one-dozen eggs 220 can be placed in a preheated oven for baking. The eggs 220 can then be stored for an extended period of time in the egg baking device 200 in the refrigerator with or without the cover 230.

The eggs 220 can then be allowed to cool in the egg baking device 200, eliminating the need for an ice water bath. If immediate cooling is desired, however, the cover 230 may be filled with cold water and used as a cooling bath by flipping the tray 202 over and letting the baked eggs 220 drop into the bath of icy water in the cover 230.

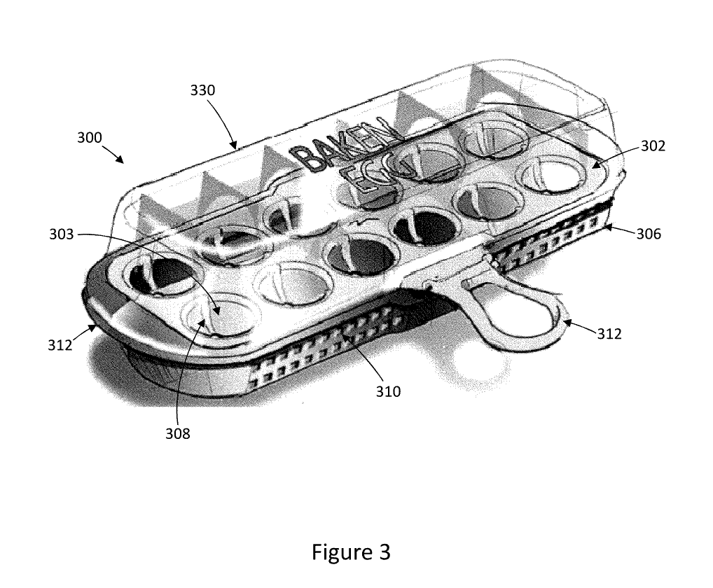

Referring now to FIG. 3, a third exemplary embodiment of an egg baking device is shown. The egg baking device 300 is similar to the egg baking device 200 shown in FIGS. 2A-2C, and provides many of the same egg cooking advantages discussed above. The egg baking device 300 includes a tray 302 having one-dozen cavities 303 for hold eggs in an upright position. The cavities 303 in the egg baking device 300 include supports 308 that allow air to flow around eggs during baking. The base 306 includes vents 310 that allow air to flow into the base 306 and around the eggs during baking. The vents 310 in the egg baking device 300 are comprised of many rectangular holes. The egg baking device 300 further includes a removable cover 330. The base 306 further includes one or more handles 312, which in certain embodiments can be configured to fold, and in other particular embodiments can serve as a latch to hold the cover 330, tray 302, and base 306 together.

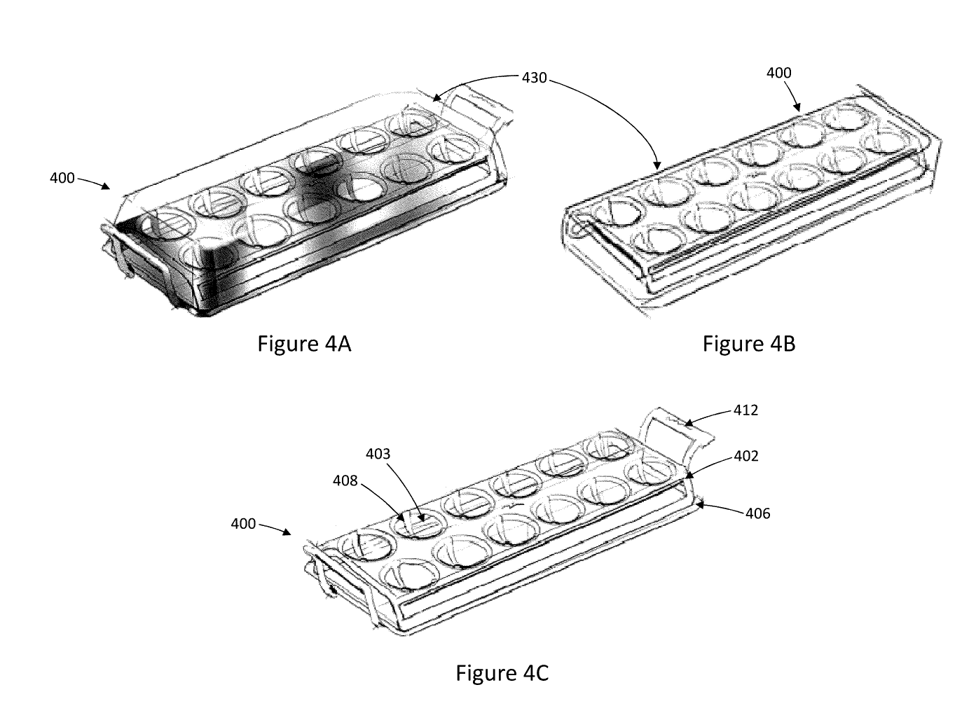

Referring to FIGS. 4A-4C, a fourth exemplary embodiment of the egg baking device is shown. The egg baking device 400 in FIGS. 4A-4C is similar to the egg baking device 200 shown in FIGS. 2A-2C, and provides many of the same egg cooking advantages discussed above. The egg baking device 400 includes a tray 402 having one-dozen cavities 403 for hold eggs in an upright position. The cavities 403 in the egg baking device 400 include supports 408 that allow air to flow around eggs during baking. The base 406 is open and allows air to flow around the tray 402 and around the eggs during baking. The base 406 further includes one or more handles 412, which in certain embodiments can be configured to fold or slide or otherwise collapse to allow for the storage of egg baking device within confined spaces.

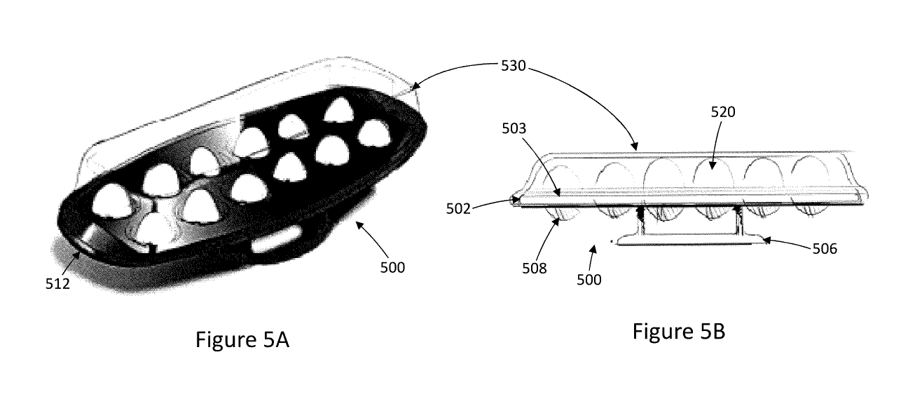

Referring to FIGS. 5A-5B, a fifth exemplary embodiment of the egg baking device is shown. The egg baking device 500 in FIGS. 5A-5B is similar to the egg baking device 200 shown in FIGS. 2A-2C, and provides many of the same egg cooking advantages discussed above. The egg baking device 500 includes a tray 502 having one-dozen cavities 503 for hold eggs 520 in an upright position. The cavities 503 in the egg baking device 500 include supports 508 that allow air to flow around eggs 520 during baking. One or more handles 512 are incorporated into the tray 502. The tray 502 further includes a stand 506 that allows the tray 502 to be placed in the oven for baking or on a table for display without the use of an additional base component.

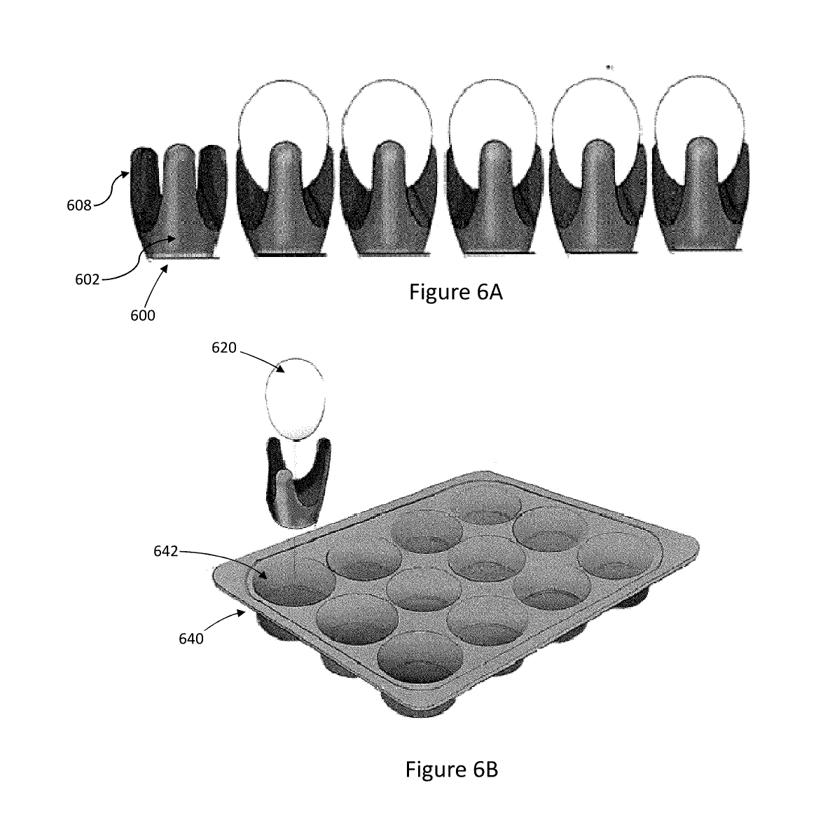

FIGS. 6A and 6B illustrate a sixth exemplary embodiment of the egg baking device. The egg baking device 600 has a base 602 from which prongs 608 extend and form a cavity 603 for holding an egg 620 during baking. The prongs 608 support the egg 620 such that air is able to flow around the egg 620 during baking, facilitating even cooking of the egg. The base 602 of the egg baking device 600 is dimensioned such that it can fit securely inside a cup 642 of a conventional muffin tin 640. This embodiment of the present application provides many of the same egg cooking advantages discussed above. By baking the eggs 620 using the egg baking device 600 together with a conventional muffin tin 640, the cook can obtain cooked eggs of any desired consistency without the use of boiling water or the use of a subsequent ice bath.

In yet additional exemplary embodiments, the egg baking device is a carton, similar to a conventional egg carton, that is constructed from a heat-resistant materials designed to withstand baking at high temperatures. By use of such an egg carton that is constructed from a heat-resistant material, eggs can be packaged, shipped, sold to end-consumers in the carton and also baked in the oven. A consumer could purchase eggs packaged in such a carton from the store, take the eggs home in the carton, and place all or some of the eggs in the same carton into an oven to bake the eggs within the carton. Furthermore, additional embodiments of the egg baking devices could comprise large scale egg trays made from a heat-resistant material designed to withstand baking at high temperatures. Such large scale egg trays could be configured to hold a large number of eggs (e.g., 30 eggs, 60 egg, etc.) for use in baking a large number of eggs for use in restaurant, military, institutional or school environments.

The egg baking devices described herein may be formed of one or more of a variety of suitable materials. The particular material is generally selected to be a heat-resistant material designed to withstand baking at high temperatures. In additional embodiments, the material is also selected to remain cool to the touch even after being exposed to the raised temperatures of an oven for prolonged periods of time. For example, in some exemplary embodiments, the egg baking device may be made from one or a combination of polymers, such as thermoplastic, thermoset or elastomeric materials. For example, in some exemplary embodiments, the egg baking device may be made of silicone rubber or polyethylene-terephthalate (PET), or mixtures thereof. In some exemplary embodiments, the egg baking device may be made from one or a combination of metals, such as steel or aluminum. In yet additional embodiments, the egg baking device may be made from a combination of polymeric materials and metals. For example, the egg baking device may be made from aluminum or steel coated with silicone rubber. The egg baking device may be manufactured by any suitable method, including any one of a variety of methods of making cookware that are well known in the art. For example, molding processes, such as injection molding, could be used with any of a variety of polymeric materials to make the egg baking device.

The use of the various exemplary egg baking devices disclosed herein provide a variety of benefits over conventional egg boiling methods. For example, the exemplary egg baking devices do not involve the use of boiling water so there is no risk of scalding. Furthermore, since no open flame is used, risks of burning are also diminished. Baking eggs using the egg baking devices disclosed herein is an easier, less labor intensive method than boiling eggs. Furthermore, it is more consistent and repeatable method of cooking eggs than boiling, as the oven temperature and baking time can be accurately and consistently controlled to ensure a fully and consistently cooked egg each time. The oven temperature and/or baking time can be adjusted to control the finished condition or “doneness” of the baked egg. For example, baked eggs having a similar consistency to hard boiled eggs or soft boiled eggs can be achieved by adjusting the baking parameters. Also, the consistency with which the eggs can be baked helps to avoid the health risks/downsides or undesirable taste/texture/appearance associated with undercooked or overcooked eggs.

Less labor and cleanup is required (and, therefore, less soap and water for cleaning purposes as a result) to clean the egg baking devices than conventional pots and cookware used for boiling eggs and the coldwater bath used for cooling the boiled eggs. Use of the egg baking devices disclosed herein also decrease the risk of egg breakage, as eggs are often broken when they are dropped into a pot of water, when they collide with one another during the pot during boiling, or even as a result of extreme temperature changes resulting from the transfer of the eggs from boiling water to the cold water bath.

The egg baking process using the egg baking devices can be more easily scaled to accommodate large batches of eggs than the boiling process. Only a limited number of eggs can be conveniently boiled at one time within a pot, but exemplary embodiments of the egg baking devices disclosed herein may be configured to hold a large number of eggs that could all be placed within an oven and baked at the same time, at the same temperature, to achieve the same consistent result. Even large flats of many eggs could be baked in this way using large egg baking trays and industrial sized ovens, for use in restaurant, military, institutional or school environments.

The egg baking devices disclosed herein can also be used with existing bakeware, such as cooking trays, cooking sheets or pie pans or other bakeware items that many people typically already possess. For example, the egg baking devices disclosed herein may be placed on or within a piece of conventional bakeware in an oven during the baking process.

While the general inventive concepts have been illustrated by the description of exemplary embodiments thereof, and while the exemplary embodiments have been described in considerable detail, it is not the intention of the applicants to restrict or in any way limit the scope of the general inventive concepts to such details. Additional advantages and modifications will readily appear to those skilled in the art. For example, where components are releasable or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the general inventive concepts, in their broader aspects, are not limited to the specific details, the representative apparatus, and illustrative examples shown and described. Accordingly, departures may be made from such details without departing from the spirit or scope of the applicant's general inventive concepts.

Furthermore, while various inventive aspects, concepts and features of the general inventive concepts may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the general inventive concepts may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of the general inventive concepts, such identification is not intended to be exclusive, but rather there may be inventive aspects, concepts and features that are fully described herein without being expressly identified as such or as part of the general inventive concepts. Any descriptions of exemplary methods or processes are not limited to inclusion of all steps as being required in all cases, nor is the order that the steps are presented to be construed as required or necessary unless expressly so stated.

1. An egg baking device comprising:
a body defining a cavity for receiving an egg to be baked, the cavity having an inner surface and a floor;
a plurality of legs; and
a plurality of vents defined in the body configured to allow air to flow through the body.

2. The egg baking device of claim 1, further comprising a plurality of ridges positioned on the inner surface of the cavity for supporting the egg within the cavity.

3. The egg baking device of claim 2, wherein the ridges support the egg such that an air gap is created between the egg and the inner surface of the cavity to facilitate even baking.

4. The egg baking device of claim 2, wherein the ridges are dimensioned and configured to hold eggs of various sizes.

5. The egg baking device of claim 1 further including a support protruding from the floor of the cavity for supporting the egg within the cavity.

6. The egg baking device of claim 1, wherein the egg baking device is formed of heat resistant material.

7. The egg baking device of claim 6, wherein the egg baking device is formed of a non-ceramic material.

8. The egg baking device of claim 6, wherein the egg baking device is formed of a non-metallic material.

9. The egg baking device of claim 6, wherein the heat resistant material is silicone rubber.

10. The egg baking device of claim 1, wherein the legs are dimensioned and configured to span across at least two rails of a conventional oven rack.

11. The egg baking device of claim 10, wherein each leg includes a foot that protrudes from the leg.

12. The egg baking device of claim 1, wherein the body sidewall has an upper rim that includes notches that are dimensioned and configured to receive the legs of another egg baking device to facilitate stacking of a plurality of the egg baking devices.

13. An egg baking device comprising:
a base;
a tray including one-dozen cavities for receiving eggs, wherein the cavities are spatially arranged to conform to the spacing of one dozen eggs of a conventional carton of one-dozen eggs.

14. The egg baking device of claim 13, wherein the base and the tray are made from heat resistant material.

15. The egg baking device of claim 13, wherein the base is removable.

16. The egg baking device of claim 13, wherein the base and tray are ventilated.

17. The egg baking device of claim 13, wherein the egg baking device includes a removable base and a cover.

18. The egg baking device of claim 17, wherein the base, tray, and cover are made from heat resistant material.

19. The egg baking device of claim 17, wherein the base, tray, and cover are ventilated.

20. An egg baking device comprising:
a base that is dimensioned and configured to fit within a cup of a conventional muffin tin;
a plurality of prongs attached to the base, wherein the arms are dimensioned and configured to support eggs of various sizes.

21. The egg baking device of claim 19, wherein the egg baking device is made from heat resistant material.

22. The egg baking device of claim 21, wherein the heat resistant material is silicone rubber.
